(19) United States
(12) Patent Application Publication
(10) Pub. No.: US 2014/0109370 A1
(43) Pub. Date: Apr. 24, 2014

(54) ASSEMBLY EQUIPMENT LINE AND METHOD FOR WINDOWS

(71) Applicant: Guardian IGU, LLC, White Bear Lake, MN (US)

(72) Inventors: Corey E. Pemberton, Prairie Du Sac, WI (US); Eric B. Rapp, Avoca, WI (US); Robert J. Onesti, Oregon, WI (US); George Longo, Corsicana, TX (US)

(73) Assignee: Guardian IGU, LLC, White Bear Lake, MN (US)

(21) Appl. No.: 14/058,481

(22) Filed: Oct. 21, 2013

Related U.S. Application Data
(60) Provisional application No. 61/716,871, filed on Oct. 22, 2012.

(51) Int. Cl. E06B 3/673

(52) U.S. Cl. CPC E06B 3/67304
USPC 29/33 P

(57) ABSTRACT

The technology disclosed herein generally relate to assembly equipment for window units. In one embodiment, a window unit assembly system is taught that has a frame component that is configured to support equipment for a window unit assembly line. A pane conveyor is supported by the frame component and is configured to move panes along the window unit assembly line. A spacer conveyor is supported by the same frame component as the pane conveyor and is configured to move spacer elements along the window unit assembly line.

### RELATED APPLICATIONS

This application is a non-provisional of “ASSEMBLY EQUIPMENT LINE AND METHOD FOR WINDOWS,” U.S. Ser. No. 61/716,871, filed Oct. 22, 2012 (Atty. Docket No. 724.0032USP1), which is incorporated herein by reference in its entirety.

This application is related to the following U.S. patent applications: “TRIPLE PANE WINDOW SPACER, WINDOW ASSEMBLY AND METHODS FOR MANUFACTURING SAME”, U.S. 2012/0151857, filed Dec. 15, 2011 (Atty. Docket No. 724.0017USU1); “SEALED UNIT AND SPACER”, U.S. 2009/0120035, filed Nov. 13, 2008 (Atty. Docket No. 724.0009USU1); “BOX SPACER WITH SIDEWALLS”, U.S. 2009/0120036, filed Nov. 13, 2008 (Atty. Docket No. 724.0012USU1); “REINFORCED WINDOW SPACER”, U.S. 2009/0120019, filed Nov. 13, 2008 (Atty. Docket No. 724.0011USU1); “SEALED UNIT AND SPACER WITH STABILIZED ELONGATE STRIP”, U.S. 2009/0120018, filed Nov. 13, 2008 (Atty. Docket No. 724.0013USU1); “MATERIAL WITH UNDULATING SHAPE” U.S. 2009/0123694, filed Nov. 13, 2008 (Atty. Docket No. 724.0014USU1); and “STRETCHED STRIPS FOR SPACER AND SEALED UNIT”, U.S. 2011/0104512, filed Jul. 14, 2010 (Atty. Docket No. 724.0015USU1); “WINDOW SPACER APPLICATOR”, U.S. 2011/0303349, filed Jun. 10, 2011 (Atty. Docket No. 724.0016USU1); “WINDOW SPACER, WINDOW ASSEMBLY AND METHODS FOR MANUFACTURING SAME”, U.S. Provisional Patent Application Ser. No. 61/386,732, filed Sep. 27, 2010 (Atty. Docket No. 724.0008USP1); “SPACER JOINT STRUCTURE”, US-2013-0042552-A1, filed on Oct. 22, 2012 (Atty. Docket No. 724.0009USI1); “ROTATING SPACER APPLICATOR FOR WINDOW ASSEMBLY”, U.S. 2013/0047404, filed on Oct. 22, 2012 (Atty. Docket No. 724.0016USI1); “SPACER HAVING A DESICCANT”, filed on Oct. 21, 2013 (Atty. Docket No. 724.0031USU1); “TRIPLE PANE WINDOW SPACER HAVING A SUNKEN INTERMEDIATE PANE”, filed on Oct. 21, 2013 (Atty. Docket No. 724.0034USU1), which are all hereby incorporated by reference in their entirety.

### TECHNOLOGICAL FIELD

The technology disclosed herein generally relates to assembly equipment. More particularly, the technology disclosed herein relates to assembly equipment for window units.

### SUMMARY

The technology disclosed herein generally relate to assembly equipment for window units. In one embodiment, a window unit assembly system is taught that has a frame component that is configured to support equipment for a window unit assembly line. A pane conveyor is supported by the frame component and is configured to move panes along the window unit assembly line. A spacer conveyor is supported by the same frame component as the pane conveyor and is configured to move spacer elements along the window unit assembly line.

In another embodiment taught herein, a window unit assembly has a frame component arranged in a window unit assembly line. A pane conveyor is supported by the frame component and is configured to move panes along the window unit assembly line in a first direction. A spacer conveyor is configured to move spacer elements along the window unit assembly line in a second direction, wherein the second direction is directly opposite to the first direction.

In yet another embodiment, the technology disclosed herein is related to a window unit assembly system that has a plurality of frame components configured to support equipment for a window unit assembly line. A plurality of pane conveyors, which are each supported by one of the frame components, are configured to move panes along the window unit assembly line. A plurality of spacer conveyors, which are each supported by one of the frame components, are configured to move spacer elements along the window unit assembly line. The plurality of frame components includes a first frame component and at least a second frame component. The first frame component supports both one of the plurality of pane conveyors and one of the plurality of spacer conveyors, and the second frame component support both another one of the plurality of pane conveyors and another one of the plurality of spacer conveyors.

### BRIEF DESCRIPTION OF DRAWINGS

FIG. 1 is a perspective view of a window assembly.

FIG. 2 is a side view of the window assembly of FIG. 1.

FIG. 3 is a perspective view of a spacer suitable for use with the window assembly of FIG. 1.

FIG. 4 is a perspective view of the spacer having a plurality of notches.

FIG. 5 is an enlarged perspective view of a portion of the spacer of FIG. 4.

FIG. 6 is a schematic view of one embodiment of a window assembly system for assembling a window unit.

FIG. 7 is a perspective view of one embodiment of a window assembly system for assembling a window unit.

FIG. 8 is a close-up perspective view of a portion of the window assembly system of FIG. 7.

FIG. 9 is a front view of the window assembly system of FIG. 7.

FIG. 10 is a perspective view of one embodiment of a window assembly system for assembling a window unit.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

A series of machines and arrangement of those machines is described herein that will allow window manufacturers to save valuable floor space while manufacturing window assemblies by combining the processing of both the panes of glazing materials, such as glass panes, and spacer materials on a single assembly line structure. In one embodiment, the panes are loaded and processed using pane conveyers while the spacer is loaded and processed using spacer conveyors, and the spacer conveyors are mounted on the same frame elements as the pane conveyors. As a result, a separate line for processing the spacer is not required and valuable floor space is conserved. Also, separate frame elements are not required, so the cost of the assembly equipment is reduced. In one embodiment, the spacer conveyors are mounted below the pane conveyors.

In one embodiment, the spacer conveyors move the spacer in a first direction along the assembly line during processing, while the pane conveyors move the panes in a second opposite direction along the assembly line during processing. In one embodiment, the second direction is 180 degrees from, or directly opposite to, the first direction. The panes and the spacer are transferred along the assembly line, in opposite directions, until they meet at a spacer application unit, which attaches a spacer to at least one pane.

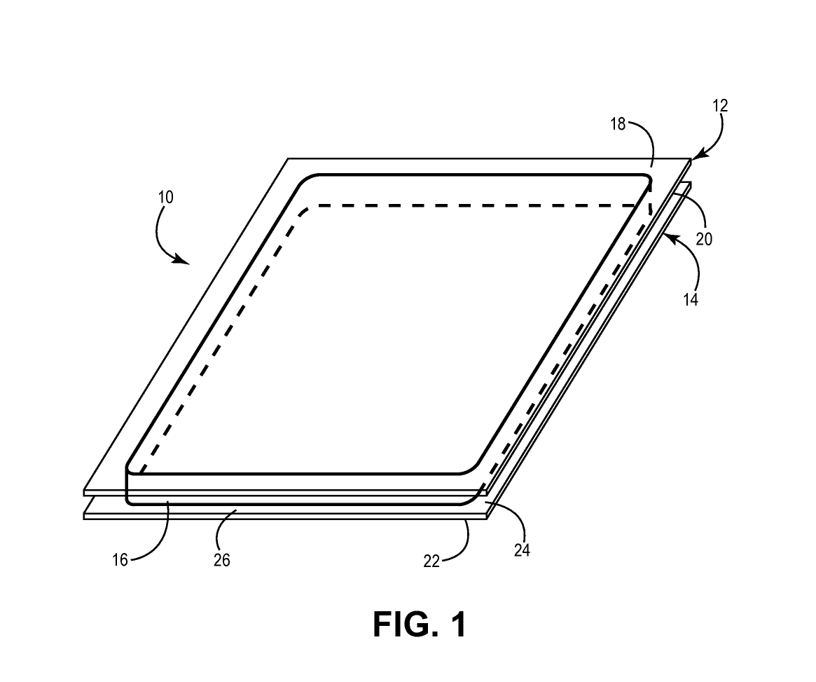

The basic structure of a window assembly will now be described in more detail with reference to FIGS. 1, 2 and 3.

Referring now to FIG. 1, a window assembly 10 is shown. The window assembly 10 includes a first pane 12, a second pane 14 and a spacer 16 disposed between the first and second panes 12, 14. In the subject embodiment, the first and second panes 12, 14 are adapted to allow at least some light to pass through the panes 12, 14. The first and second panes 12, 14 are made of a translucent or transparent material. In the subject embodiment, the first and second panes 12, 14 are made of a glass material. In another embodiment, the first and second panes 12, 14 are made of a plastic material.

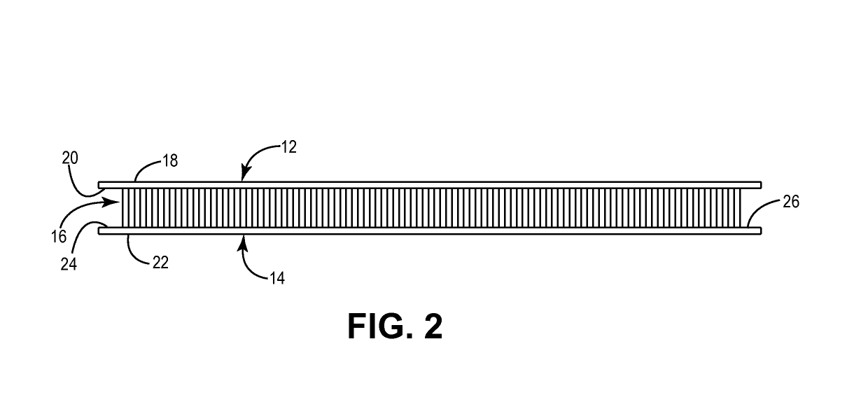

Referring now to FIG. 2, the first pane 12 includes a first surface 18 and an oppositely disposed second surface 20. The second pane 14 includes a first surface 22 and an oppositely disposed second surface 24.

The spacer 16 is disposed between the first and second panes 12, 14 to keep the first and second panes 12, 14 spaced apart from each other. The spacer 16 is shaped into a spacer frame. The spacer 16 is adapted to withstand compressive forces applied to the first and second panes 12, 14 and to maintain a desired space between the first and second panes 12, 14.

The spacer 16 is sealingly engaged to each of the first and second panes 12, 14 at an edge portion 26 of each of the first and second panes 12, 14. The edge portion 26 is adjacent to the outer perimeter of the panes. In the depicted embodiment, the spacer 16 is sealingly engaged to the second surface 20 of the first pane 12 and the second surface 24 of the second pane 14.

FIGS. 1 and 2 illustrate one possible embodiment of a window assembly unit that can be manufactured using the methods and equipment described herein. However, other window assembly units could also be made using the methods and equipment described herein. For example, a triple pane window unit could be manufactured using many of the techniques described herein.

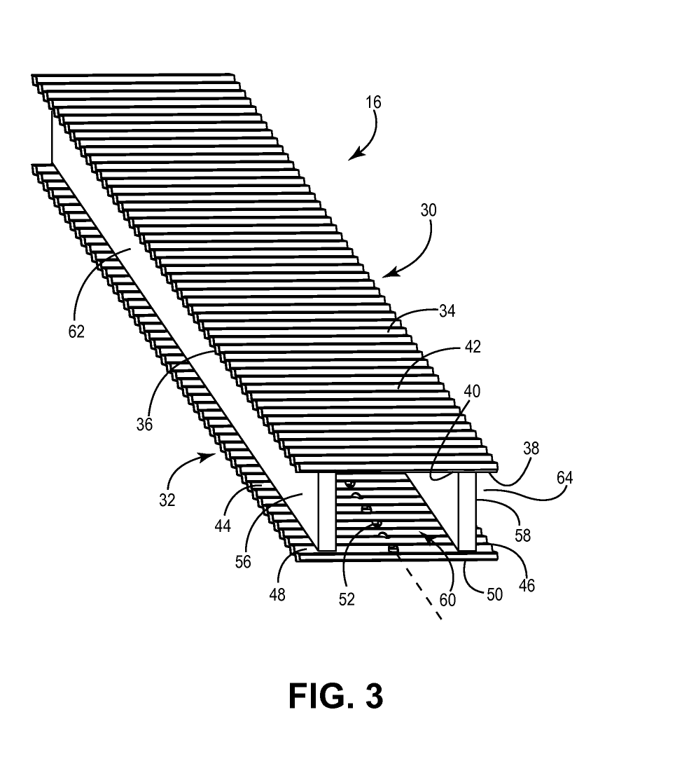

Referring now to FIG. 3, one embodiment of a spacer 16 is shown. Further options for a spacer suitable for use with the window assembly 10 are numerous and some have been described in the other patent applications and patents that are incorporated by reference herein.

The spacer 16 includes a first strip 30 of material and a second strip 32 of material. The first and second strips 30, 32 are generally flexible in both bending and torsion. In some embodiments, bending flexibility allows the spacer 16 to be bent to form non-linear shapes (e.g., curves). Bending and torsional flexibility also allows for ease of window manufacturing. Such flexibility includes either elastic or plastic deformation such that the first and second strips 30, 32 do not fracture during installation into window assembly 10. Some embodiments of spacer 16 include strips that do not have substantial flexibility, but rather are substantially rigid. In some embodiments, the first and second strips 30, 32 are flexible, but the resulting spacer 16 is substantially rigid.

In one embodiment, the first and second strips 30, 32 are formed from a metal material or a plastic material. In the depicted embodiment, each of the first and second strips 30, 32 has a plurality of undulations 34. The first strip 30 includes a first side portion 36 and an oppositely disposed second side portion 38. The first strip 30 further includes a first surface 40 and an oppositely disposed second surface 42. The second strip 32 includes a first side portion 44 and an oppositely disposed second side portion 46. The second strip 32 further includes a first surface 48 and an oppositely disposed second surface 50.

The second strip 32 includes a plurality of passages 52 that extend through the first and second surfaces 48, 50 of the second strip 32. In the depicted embodiment, the passages 52 are generally aligned along a central longitudinal axis 54 of the second strip 32. Other embodiments include other arrangements of passages 52, such as multiple rows of passages 52. Passages can be openings or apertures of any shape including slits, circular apertures, or the like.

The spacer 16 includes a first sidewall 56 and a second sidewall 58. The first and second sidewalls 56, 58 extend between the first strip 30 and the second strip 32. In the depicted embodiment, the first sidewall 56 is engaged to the first side portion 36 on the first surface 40 of the first strip 30 and the first side portion 44 on the first surface 48 of the second strip 32. In one embodiment, the first and second sidewalls 56, 58 extend the length of the first and second strips 30, 32.

Each of the first and second elongate strips 30, 32 includes a first elongate edge and a second elongate edge. The first elongate edge is at the edge of the first side portion 36, 44 of each strip and the second elongate edge is at the edge of the second side portion 38, 46 of each strip. The first extruded sidewall 56 is closer to the first side portion 36, 44 of each strip 30, 32 than to the second side portion 38, 46 of each strip 30, 32. The first sidewall 56 is offset from the first edge of the first elongate strip 30 and from the first edge of the second elongate strip 32 by a first offset distance. The second extruded sidewall 58 is closer to the second side portion 38, 46 of each strip 30, 32 than to the first side portion 36, 44 of each strip 30, 32. The second sidewall 58 is offset from the second edge of the first elongate strip and from the second edge of the second elongate strip by a second offset distance that will be substantially similar to the first offset distance.

In one embodiment, the first and second sidewalls 56, 58 are manufactured from a plastic material. The plastic material can be extruded, rolled or molded to form the first and second sidewall 56, 58.

The first and second strips 30, 32 and the first and second sidewalls 56, 58 cooperatively define an interior region 60 of the spacer 16. In one embodiment, a filler material is added to the interior region 60. An exemplary filler material that may be added to the interior region 60 is and/or includes a desiccant material. In the event that moisture is present between the first and second panes 12, 14 (FIGS. 1 and 2), the moisture passes through the passages 52 of the second strip 32 and is absorbed by the desiccant material in the interior region 60 of the spacer 16.

The first side portion 36 of the first strip 30, the first sidewall 56 and the first side portion 44 of the second strip 32 cooperatively define a first side 62 of the spacer 16. The second side portion 38 of the first strip 30, the second sidewall 58 and the second side portion 46 of the second strip 32 cooperatively define a second side 64 of the spacer 16. The interior region 60 is disposed between the first and second sides 62, 64 of the spacer 16.

Many additional spacer embodiments can be used with the assembly system described herein, including spacers constructed of foam, for example. The spacer embodiment of FIG. 3 is just one example of a spacer element that can be used with the assembly system described herein.

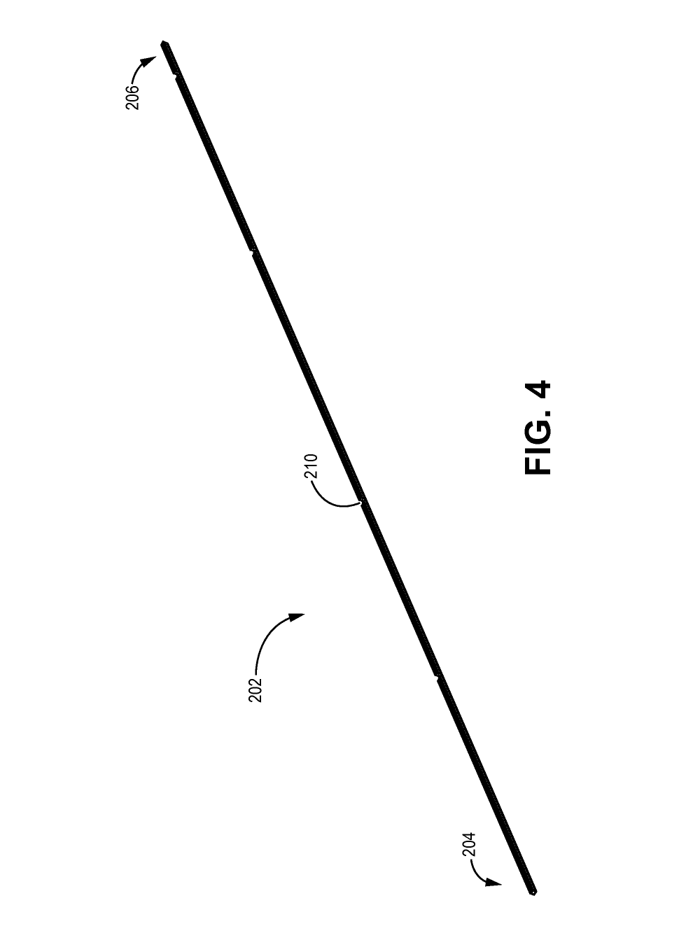

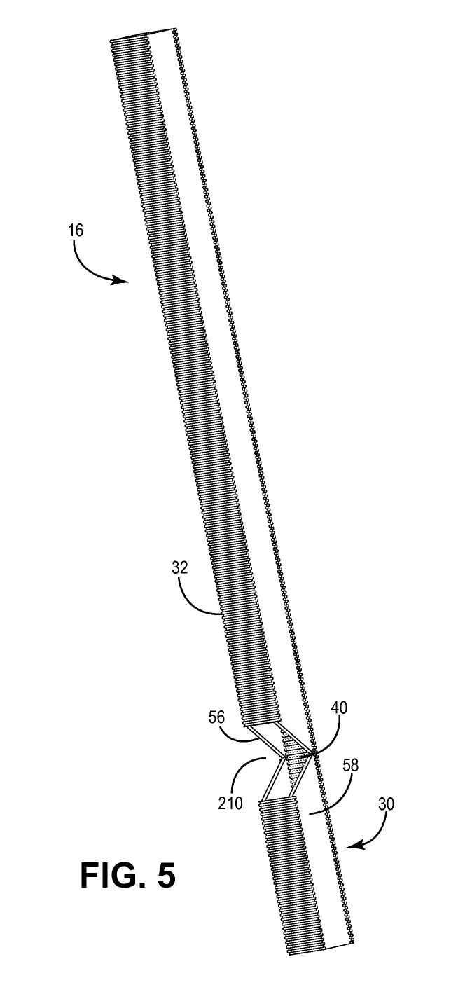

In some embodiments of the window assembly system, a reeled length of spacer is provided to the assembly system coiled on a storage spool. The reeled length of spacer on the spool is much longer than is needed for assembly of each individual window unit. In one embodiment, the reeled length of spacer is continuously wrapped about the storage spool. During the window assembly process, the reeled length of spacer is unreeled and cut into discrete spacer elements 202, such as shown in FIG. 4, having a first end 204 and a second end 206. In one embodiment, each discrete spacer element 202 is sized to be bent to form a spacer frame that is adjacent to the entire perimeter of a window unit 10 (FIG. 1). In one embodiment, the spacer element 202 can include corner notches 210, as shown in FIGS. 4 and 5, to facilitate bending of the spacer element 202 at the corners of the window unit. In other embodiments, discrete spacer elements are each sized to be positioned along a single side of the window unit.

In the depicted embodiment of FIGS. 4 and 5, the notches 210 are generally V-shaped. Each notch 210 extends through the second strip 32, the first and second sidewalls 56, 58 and up to partially through the first surface 40 of the first strip 30. In the depicted embodiment, the notch 210 defines an angle that is about 90 degrees, although the angle of the corner notch 210 can have different measurements depending on the desired angle measurement of the resultant corner in the formed spacer frame.

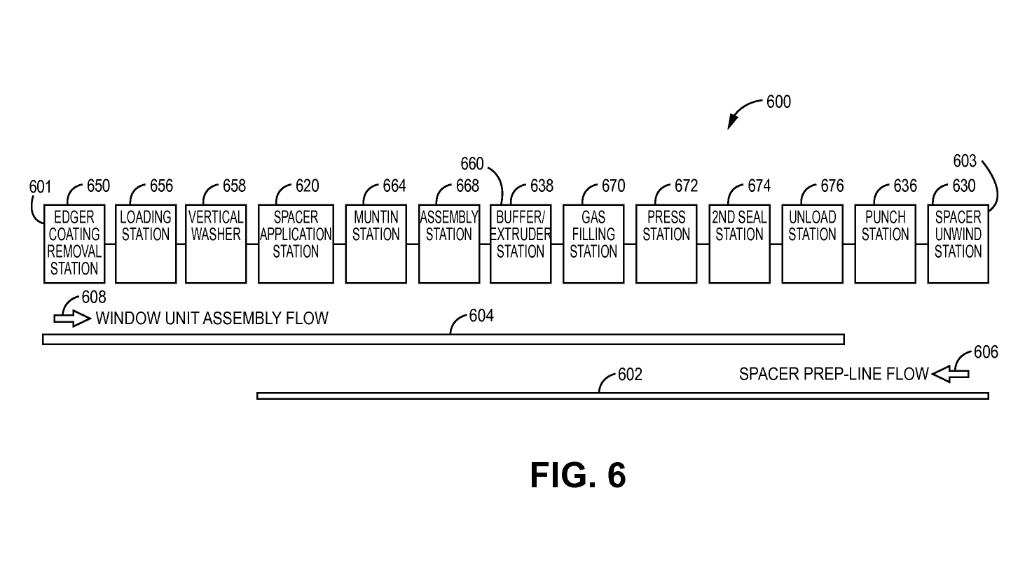

FIG. 6 is a schematic view of a series of machines arranged into a window assembly system 600. The system 600 includes many machines that can be roughly divided into two types of equipment: spacer processing equipment and window unit assembly equipment. The spacer processing equipment generally acts on the spacer element alone to prepare the spacer for incorporation into a window unit, which may also be referred to as a glazing unit. The window unit assembly equipment generally acts on the panes, joins the panes with the spacer to form subassemblies, acts on the subassemblies to form window units, and acts on the window units. The spacer processing equipment is provided with spacer conveyor elements 602 to move the spacer from machine to machine. The window unit assembly equipment is provided with pane conveyors 604 that move the panes of material from machine to machine, and then move the assembled window unit from machine to machine for further processing. Some pieces of equipment, such as the spacer application unit, could be described as both spacer processing equipment and window unit assembly equipment.

In one embodiment, the spacer conveyors 602 move the spacer in a first direction indicated by arrow 606 along the assembly line 600 during processing, while the pane conveyors 604 move the panes and window units in a second opposite direction indicated by arrow 608 during processing. In the embodiment of FIGS. 6-9, the second direction is 180 degrees from, or directly opposite to, the first direction. The panes and the spacer are transferred along the assembly line, in opposite directions, as they undergo processing steps, until they meet at a spacer application unit 620. The spacer application unit 620 assembles a discrete length of the spacer into a spacer frame and applies the spacer frame to a pane to form a pane/spacer subassembly. Then the subassembly proceeds in the second direction indicated by arrow 608 along pane conveyors 604 to undergo further processing steps.

The assembly system 600 has a first end 601 and a second end 603. In one embodiment, the panes are input at the first end 601 and the pane conveyors 604 are present at the first end 601 and continue in the second direction 608. In one embodiment, the spacers are input at the second end 603 and the spacer conveyors 606 are present at the second end 603 and continue in the first direction 606.

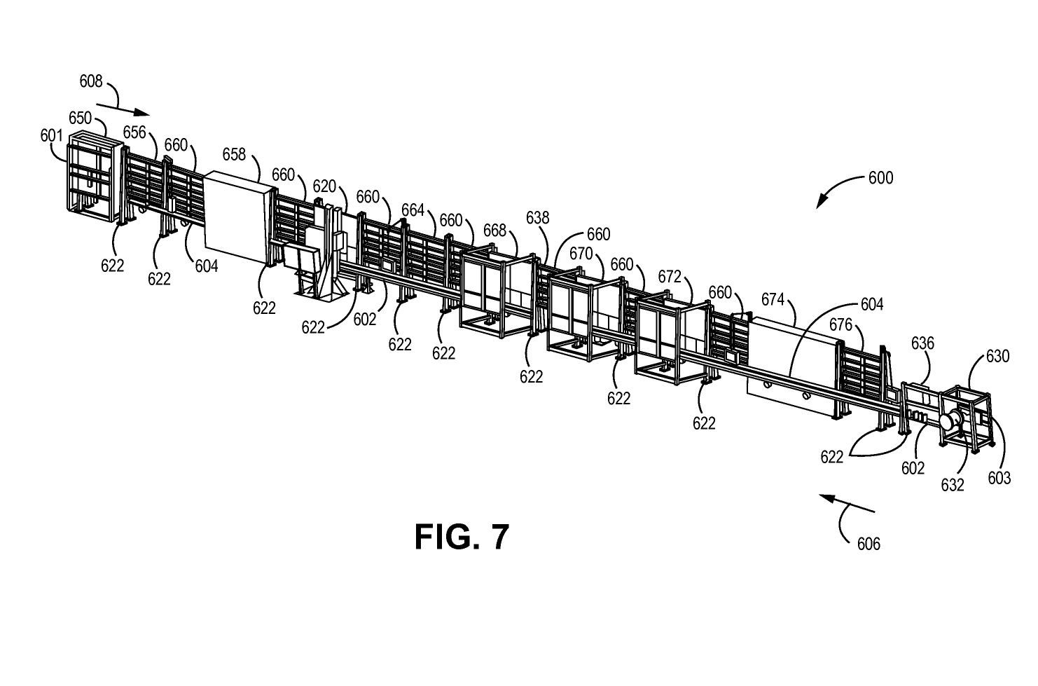

FIG. 7 is a perspective view of one embodiment of a window unit assembly system 600. The arrows 606, 608 indicating the direction of movement of the spacers and panes, respectively, are shown in FIG. 7. The spacer conveyors 602 and pane conveyors 604 are also labeled in FIG. 7, although they are small in the representation of FIG. 7. The machines of the assembly line 600 are supported by frame elements 622 shown in FIG. 7, which are positioned along the assembly line. In one embodiment, at least some of the spacer conveyors 602 and pane conveyors 604 are supported by the same frame elements 622.

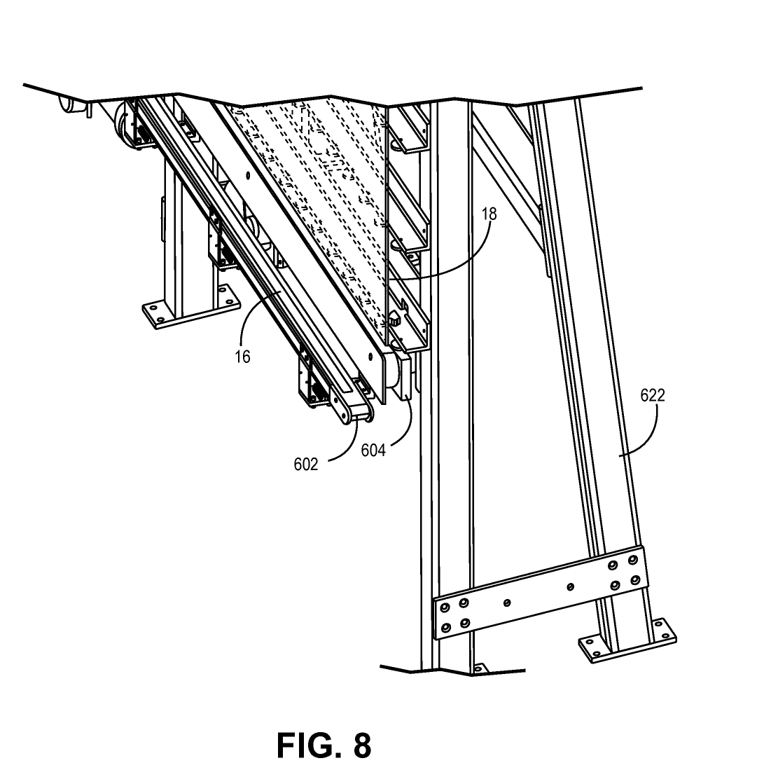

FIG. 8 shows a close up view of one portion of a frame element 622 where both a spacer conveyer 602 and a pane conveyor 604 are supported by the same frame element 622. As a result, a separate line for processing the spacer is not required and valuable floor space is conserved. Also, separate frame elements are not required, so the cost of the assembly equipment is reduced. A conveyor is any type of mechanical apparatus that moves articles from place to place. One example of a conveyor that is illustrated in FIG. 8 includes two or more pulleys and a continuous loop of material that rotates around the pulleys. Many other options for conveyors may be used with the embodiments described herein.

In the embodiment of FIGS. 7-9, the spacer conveyors are mounted below the pane conveyors. Other arrangements are also possible, such as spacer conveyors being mounted above the pane conveyors.

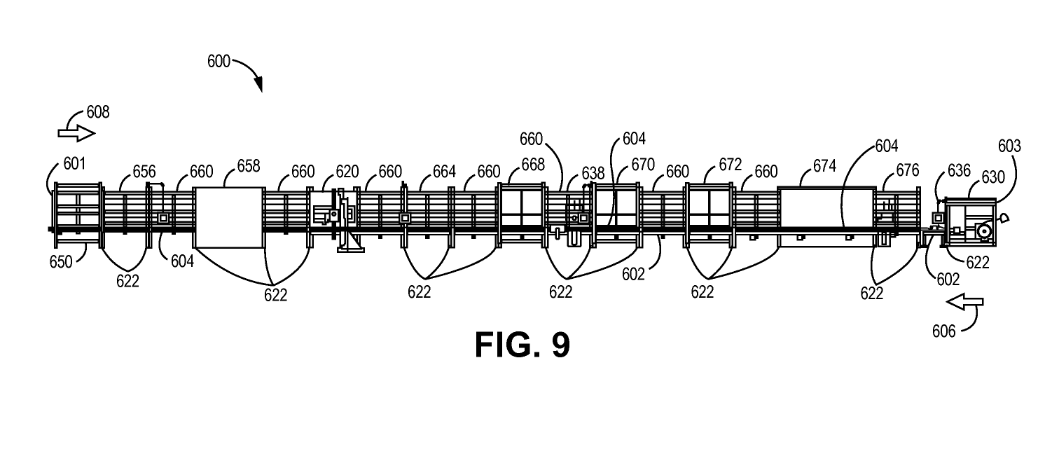

FIG. 9 is a front view of the window unit assembly system 600 of FIG. 7. Now referring to FIGS. 6, 7 and 9, examples of machines included in the window assembly system 600 will now be described. However, these examples should not be considered limiting, as many different types of machines may be present on a window assembly line. The patents and patent applications incorporated herein by reference provide further examples of and further descriptions of machines that can be located in a window unit assembly system.

First, some examples of spacer processing equipment will be provided. One example of spacer processing equipment is an unwind station 630 to unwind a length of spacer from a longer reeled length of spacer on a spool 632 for incorporation into a window unit. The spacer processing equipment can also include a punching station 636 for punching corner notches into the length of spacer and for cutting the ends of the spacer length to separate the discrete spacer length from the reeled spacer. An extruder station 638 is used to extrude sealant onto the spacer, in some embodiments. For the spacer 16 shown in FIG. 3, the sealant is extruded into the cavities present at the first side 62 and the second side 64 of the spacer 16. The spacer with sealant is conveyed to the spacer application station 620. In one embodiment, the spacer application station 620 wraps the spacer around a spacer retention structure to shape the spacer into a spacer frame. The spacer frame may have a rectangular shape or another closed shape. The spacer application station 620 then applies the wrapped spacer to a pane that is present on a pane conveyor at the spacer application station 620.

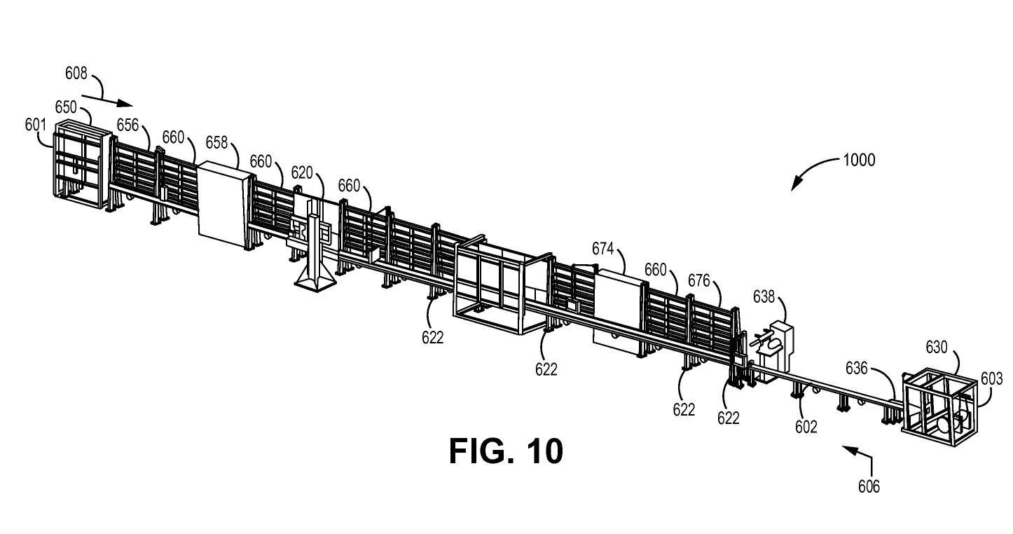

In one embodiment, the spacer conveyors 602 are present from a second end 603 of the system line 600 to the spacer application station 620. In the embodiment of FIGS. 6-9, the extruder station 638 is present at the same location as another piece of window unit assembly equipment, such as a buffer station 660. Both spacer conveyors 602 and pane conveyors 604 are present at the combination of the extruder station 638 and the buffer 660. In the spacer flow of the first direction 606, the extruder station 638 is upstream from the spacer application station 620 but not upstream from all the rest of the window unit assembly equipment. This aspect is in contrast with the embodiment of FIG. 10, where the extruder station 638 is upstream from all of the window unit assembly equipment.

Examples of window unit assembly equipment will now be provided, starting at one end of the assembly line and moving in the second direction indicated by arrow 608. The system 600 includes an edge coating removal station 650, where edge coatings can be removed from the panes, a loading station 656, where panes can be loaded onto a pane conveyor 604, and a vertical washer 658, where panes can be washed. Although only one is pictured in the schematic drawing of FIG. 6, the system may include several buffer conveyor units 660 that are illustrated in FIGS. 7 and 9 and may be positioned between some of the other machines. The buffer conveyor units 660 serve to hold a pane on pane conveyors 604 to be ready for the next step in the process.

The pane is delivered by pane conveyors 604 from the first end 601 of the system 600 to the spacer application station 620 where a pane is joined to a spacer frame, in one embodiment, forming a pane/spacer subassembly. The pane/spacer subassembly is moved in the second direction of arrow 608 to further processing machines. One example of such a machine is a muntin station 664, which applies muntin bars or other structures that will be located between the first and second panes to the pane/spacer subassembly, if appropriate for the window unit being assembled. The pane/spacer subassembly then moves to the assembly station 668 where the second pane is attached to the spacer to form a window unit. The window unit moves to the buffer conveyor station 660, which is held on the same frame element 622 as the sealant extruder station 638. Next the window unit moves to the gas filling station 670, which fills the space between the first and second panes with a selected gas or gas mixture. Next the window unit moves to the press station 672 where it is pressed to a specified thickness. The pressure provided at this step wets out the sealant connections within the window assembly. Then the window unit moves to the second seal station 674 where sealant is applied around the perimeter of the window unit adjacent to the spacer 16 (FIG. 1). Finally the window unit moves to the unload station 676 where the window unit can be unloaded. In one embodiment, the pane conveyors 604 are present along the system line 600 from a first end 601 to the unload station 676, and are not present at the punch station 636 or spacer unwind station 630, which are examples of spacer processing equipment.

FIG. 10 illustrates an alternate embodiment 1000 of a window unit assembly system. System 1000 has many elements in common with system 600 of FIGS. 7-9, and like reference numbers are used to refer to like parts. In system 1000, the extruder station 638, which applies sealant to the spacer before it is applied to a pane, is located at a different location compared to system 600. In system 600, the extruder station 638 is located on the same frame element 622 as a buffer conveyor 660 and in between machines that are used to process the panes, subassemblies and window units. In system 600, the extruder station 636 is located between the assembly station 668 and the gas filling station 670.

In system 1000, the extruder station 638 is located at one end of a row of window unit assembly equipment machines that are used to process the panes, subassemblies and the window units. Like system 600, in system 1000 the spacer moves along spacer conveyor elements in a first direction indicated by arrow 606 while the panes, subassemblies and window units move in a second direction indicated by arrow 608. The spacer conveyors transport the spacer with sealant from the extruder station 638 to the spacer application station 620 where the spacer is shaped to form a spacer frame and applied to a pane. Like system 600, in system 1000 many of the spacer conveyors and pane conveyors are located on common frame elements 622.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A window unit assembly system comprising:
a frame component configured to support equipment for a window unit assembly line;
a pane conveyor configured to move panes along the window unit assembly line, wherein the pane conveyor is supported by the frame component;
a spacer conveyor configured to move spacer elements along the window unit assembly line, wherein the spacer conveyor is supported by the same frame component as the pane conveyor.

2. The system of claim 1 wherein the spacer conveyor is located below the pane conveyor on the frame component.

3. The system of claim 1 wherein:
the pane conveyor is configured to move panes along the window unit assembly system in a first direction;
the spacer conveyor is configured to move spacer elements along the window unit assembly system in a second, opposite direction.

4. The system of claim 3 wherein the second direction is about 180 degrees from the first direction.

5. The system of claim 1 further comprising a storage spool including a length of a spacer.

6. The system of claim 1 further comprising an extruder station for applying sealant to sides of a spacer, wherein the extruder station is supported on an extruder station frame element, wherein a pane conveyor and a spacer conveyor are also supported on the extruder station frame element.

7. The system of claim 1 further comprising
a punch station adapted to cut the spacer to a desired length and to score the spacer at defined corner locations;
a sealant extruder adapted to apply sealant to first and second sides of the spacer; and
a spacer applicator adapted to automatically shape the spacer into a frame and assemble the spacer frame onto a pane.

8. The system of claim 7 wherein the corner registration mechanism, filler applicator, sealant extruder, cutter and spacer applicator assembly are configured to operate substantially simultaneously.

9. The system of claim 8, wherein the punch station, sealant extruder, and spacer application station are configured to operate substantially simultaneously on different lengths of spacers.

10. A window unit assembly system comprising:
a frame component arranged in a window unit assembly line;
a pane conveyor configured to move panes along the window unit assembly line in a first direction, wherein the pane conveyor is supported the frame component;
a spacer conveyor configured to move spacer elements along the window unit assembly line in a second direction, wherein the second direction is about 180 degrees from the first direction.

11. The system of claim 10 wherein the spacer conveyor is supported by the same frame components as the pane conveyor.

12. The system of claim 11 wherein the spacer conveyor is located below the pane conveyor on the frame components.

13. The system of claim 10 further comprising an extruder station for applying sealant to sides of a spacer, wherein the extruder station is supported on an extruder station frame element, wherein a pane conveyor and a spacer conveyor are also supported on the extruder station frame element.

14. A window unit assembly system comprising:
a plurality of frame components configured to support equipment for a window unit assembly line;
a plurality of pane conveyors configured to move panes along the window unit assembly line, wherein each pane conveyor is supported by one of the frame components;
a plurality of spacer conveyors configured to move spacer elements along the window unit assembly line, wherein each spacer conveyor is supported by one of the frame components;
wherein the plurality of frame components includes a first frame component that supports both one of the plurality of pane conveyors and one of the plurality of spacer conveyors;
wherein at least a second frame component support both another one of the plurality of pane conveyors and another one of the plurality of spacer conveyors.

15. The system of claim 14 wherein the first frame component supports a spacer application station.

16. The system of claim 15 wherein the second frame component supports a buffer conveyor for panes and a sealant extruder station for spacers.

17. The system of claim 14, wherein the plurality of spacer conveyors are located below the plurality of pane conveyors.

18. The system of claim 14, wherein the plurality of pane conveyors are further configured to move panes in a first direction and the plurality of spacer conveyors are further configured to move spacer elements in a second direction that is directly opposite the first direction.

19. The system of claim 14, further comprising a storage spool having a reeled length of a spacer.

20. The system of claim 15 wherein the spacer applicator station comprises a spacer retention structure to shape a spacer into a spacer frame.
